(19) United States
(12) Patent Application Publication
(10) Pub. No.: US 2017/0067522 A1
(43) Pub. Date: Mar. 9, 2017

(54) BRAKE ACTUATOR APPARATUS FOR AN AIR DISC BRAKE OF A VEHICLE AIR BRAKING SYSTEM

(71) Applicant: Bendix Spicer Foundation Brake LLC, Elyria, OH (US)

(72) Inventors: Daniel E. Banks, Climax, MI (US); Thomas L. Runels, Battle Creek, MI (US); Thomas E. Lyon, Lawton, MI (US); Jeffrey L. Jones, Battle Creek, MI (US)

(73) Assignee: BENDIX SPICER FOUNDATION BRAKE LLC, Elyria, OH (US)

(21) Appl. No.: 14/844,641

(22) Filed: Sep. 3, 2015

(51) Int. Cl. F16D 65/18

(52) U.S. Cl. CPC F16D 65/18; F16D 2125/48

(57) ABSTRACT

A brake actuator apparatus is provided for an air disc brake of a vehicle air braking system. The apparatus comprises a bridge housing having (i) a first end portion, (ii) a second end portion distal from the first end portion, (iii) a vehicle outboard surface extending between the first and second end portions, and (iv) a vehicle inboard surface extending between the first and second end portions. The apparatus further comprises a first tappet having a longitudinal central axis and disposed at the first end portion and extending between the outboard surface and the inboard surface, and a second tappet having a longitudinal central axis and disposed at the second end portion and extending between the outboard surface and the inboard surface. The apparatus also comprises a gear train disposed on the outboard surface and including a plurality of gear wheels operatively coupled to the tappets.

### BACKGROUND

The present application relates to air disc brakes of vehicle air braking systems, and is particularly directed to a brake actuator apparatus for an air disc brake of a vehicle air braking system, such as an air braking system of a commercial vehicle like a truck.

Air disc brakes convert air pressure into braking force. More specifically, when a foot brake is applied, compressed air enters through a supply port into a service brake chamber to apply pressure to a diaphragm. The pressure pushes the diaphragm, moving a pressure plate and pushrod against a cup in a lever. The lever pivots on an eccentric bearing and transfers motion to an actuating beam. The actuating beam moves against a return force of a spring to move two threaded tappet sleeves and tappets. This movement of the two threaded tappet sleeves and tappets forces an inner brake pad into contact with a brake rotor. Further movement of the actuating beam forces a caliper, sliding on two stationary guide pins, away from the brake rotor. This movement of the caliper pulls an outer brake pad into the brake rotor to clamp the brake rotor in a braked position between the inner and outer brake pads to apply a braking force to a vehicle wheel which is attached to the brake rotor.

When the foot brake is released, pressure in the service brake chamber is released. With no pressure in the service brake chamber, the return force of the spring forces the air disc brakes from the braked position to a neutral, non-braked position. The non-braked position is mechanically controlled by a brake adjusting mechanism in the caliper. More specifically, the brake adjusting mechanism turns the two threaded tappet sleeves and tappets to set a gap (i.e., a running clearance) between the brake rotor and the brake pads. Whenever the air disc brakes are activated, the brake adjuster mechanism operates automatically to turn the two threaded tappet sleeves and tappets to compensate for brake rotor wear and brake pad wear and keep the running clearance constant.

The automatic adjustment of the two threaded tappet sleeves and tappets needs to be synchronized. Otherwise, the tappet sleeves and tappets can become unbalanced, adjust disproportionately, and apply unequal forces to the brake pads. It would be desirable to provide a design of a brake adjuster mechanism which has improved strength, lower weight, and smaller size, as well as more accurate synchronization of tappet sleeves and tappets.

### SUMMARY

In accordance with one embodiment, a brake actuator apparatus is provided for an air disc brake of a vehicle air braking system. The brake actuator apparatus comprises a bridge housing having (i) a first housing end portion, (ii) a second housing end portion distal from the first housing end portion, (iii) a vehicle outboard surface extending between the first and second housing end portions, and (iv) a vehicle inboard surface extending between the first and second housing end portions. The brake actuator apparatus further comprises a first tappet having a longitudinal central axis and disposed at the first housing end portion of the bridge housing and extending between the vehicle outboard surface and the vehicle inboard surface, and a second tappet having a longitudinal central axis and disposed at the second housing end portion of the bridge housing and extending between the vehicle outboard surface and the vehicle inboard surface. The brake actuator apparatus also comprises a gear train disposed on the vehicle outboard surface of the bridge housing and including a plurality of gear wheels operatively coupled to the first and second tappets.

In accordance with another embodiment, a brake actuator apparatus is provided for an air disc brake of a vehicle air braking system. The brake actuator apparatus comprises a bridge housing having (i) a first housing end portion, (ii) a second housing end portion distal from the first housing end portion, (iii) a vehicle outboard surface extending between the first and second housing end portions, and (iv) a vehicle inboard surface extending between the first and second housing end portions. The brake actuator apparatus further comprises a faceplate having a major side surface facing the vehicle outboard surface of the bridge housing, a first coil spring having a longitudinal central axis and compressed between the major side surface of the faceplate and the vehicle outboard surface at the first housing end portion of the bridge housing, and a second coil spring having a longitudinal central axis and compressed between the major side surface of the faceplate and the vehicle outboard surface at the second housing end portion of the bridge housing. The brake actuator apparatus also comprises a clutch mechanism disposed in the bridge housing between the first and second housing end portions and between the vehicle inboard surface and the vehicle outboard surface, wherein the clutch mechanism has a longitudinal central axis which lies between the longitudinal central axes of the first and second coil springs.

In accordance with yet another embodiment, a brake actuator apparatus is provided for an air disc brake of a vehicle air braking system. The brake actuator apparatus comprises a bridge housing having (i) a first housing end portion, (ii) a second housing end portion distal from the first housing end portion, (iii) a vehicle outboard surface extending between the first and second housing end portions, and (iv) a vehicle inboard surface extending between the first and second housing end portions. The brake actuator apparatus further comprises a first tappet having a longitudinal central axis disposed at the first housing end portion of the bridge housing and extending between the vehicle outboard surface and the vehicle inboard surface, and a second tappet having a longitudinal central axis disposed at the second housing end portion of the bridge housing and extending between the vehicle outboard surface and the vehicle inboard surface. The brake actuator apparatus also comprises a faceplate having a major side surface facing the vehicle outboard surface of the bridge housing, a first coil spring having a longitudinal central axis and compressed between the major side surface of the faceplate and the vehicle outboard surface at the first housing end portion of the bridge housing, a second coil spring having a longitudinal central axis and compressed between the major side surface of the faceplate and the vehicle outboard surface at the second housing end portion of the bridge housing, and a clutch mechanism having a longitudinal central axis and disposed in the bridge housing between the first and second housing end portions and between the vehicle inboard surface and the vehicle outboard surface. The brake actuator apparatus further comprises a gear train disposed on the vehicle outboard surface of the bridge housing and including a (i) a center gear wheel having a longitudinal central axis which is coincident with the longitudinal central axis of the clutch mechanism, (ii) a first idler gear wheel having a longitudinal central axis which is coincident with the longitudinal central axis of the first coil spring and meshingly engaged with the center gear wheel, (iii) a first tappet gear wheel having a longitudinal central axis which is coincident with the longitudinal central axis of the first tappet and meshingly engaged with the first idler gear wheel, (iv) a second idler gear wheel having a longitudinal central axis which is coincident with the longitudinal central axis of the second coil spring and meshingly engaged with the center gear wheel, and (v) a second tappet gear wheel having a longitudinal central axis which is coincident with the longitudinal central axis of the second tappet and meshingly engaged with the second idler gear wheel. The center gear wheel, the first and second idler gear wheels, and the first and second tappet gear wheels are substantially the same size. The longitudinal central axes of the center gear wheel, the first and second idler gear wheels, and the first and second tappet gear wheels lie in substantially the same plane and are substantially parallel to each other.

### BRIEF DESCRIPTION OF THE DRAWINGS

FIG. 1 is a perspective view of a brake actuator apparatus constructed in accordance with an embodiment.

FIG. 2 is another perspective view, looking approximately in the direction of arrow “A” shown in FIG. 1, of the brake actuator apparatus.

FIG. 3 is an exploded view, looking from the perspective shown in FIG. 1, of components of the brake actuator apparatus.

FIG. 4 is an exploded view, looking from the perspective shown in FIG. 2, of components of the brake actuator apparatus.

FIG. 5 is an elevational view, looking approximately downward from the top of FIG. 1, of the brake actuator apparatus.

FIG. 6 is a sectional view, taken approximately along line 6-6 shown in FIG. 5, and showing certain components of the brake actuator apparatus.

FIG. 7 is a sectional view, taken approximately along line 7-7 shown in FIG. 5, and showing certain components of the brake actuator apparatus.

FIG. 8 is a sectional view, taken approximately along line 8-8 shown in FIG. 5, and showing certain components of the brake actuator apparatus.

### DETAILED DESCRIPTION

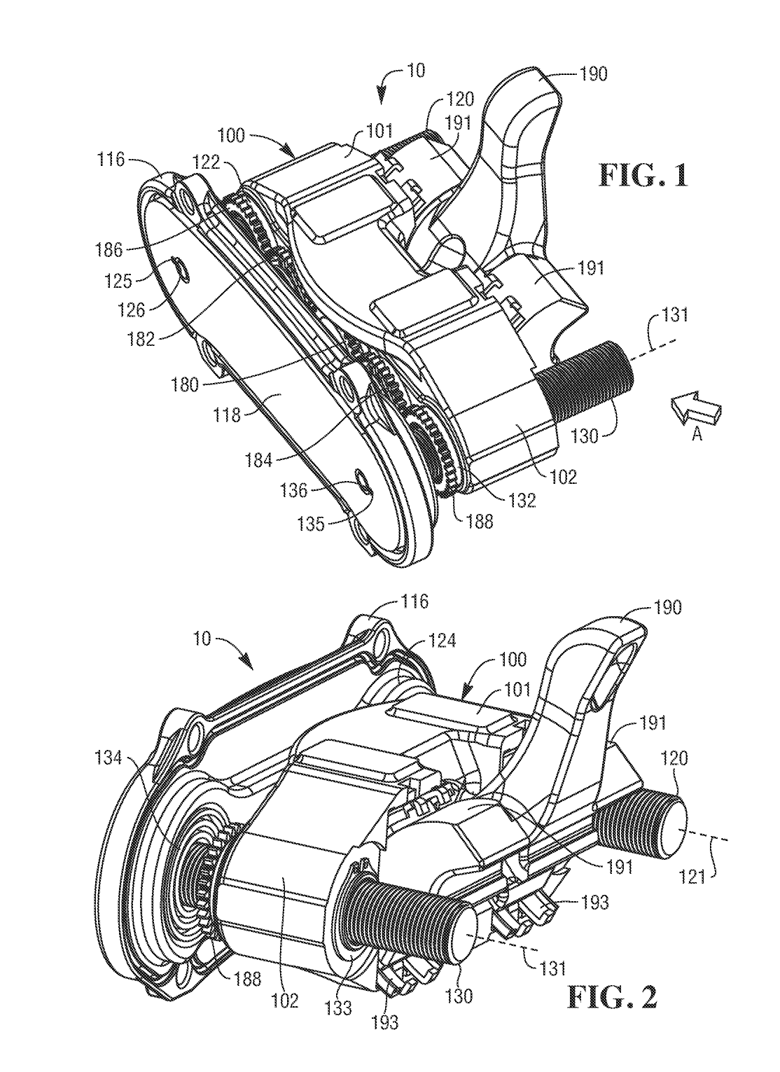

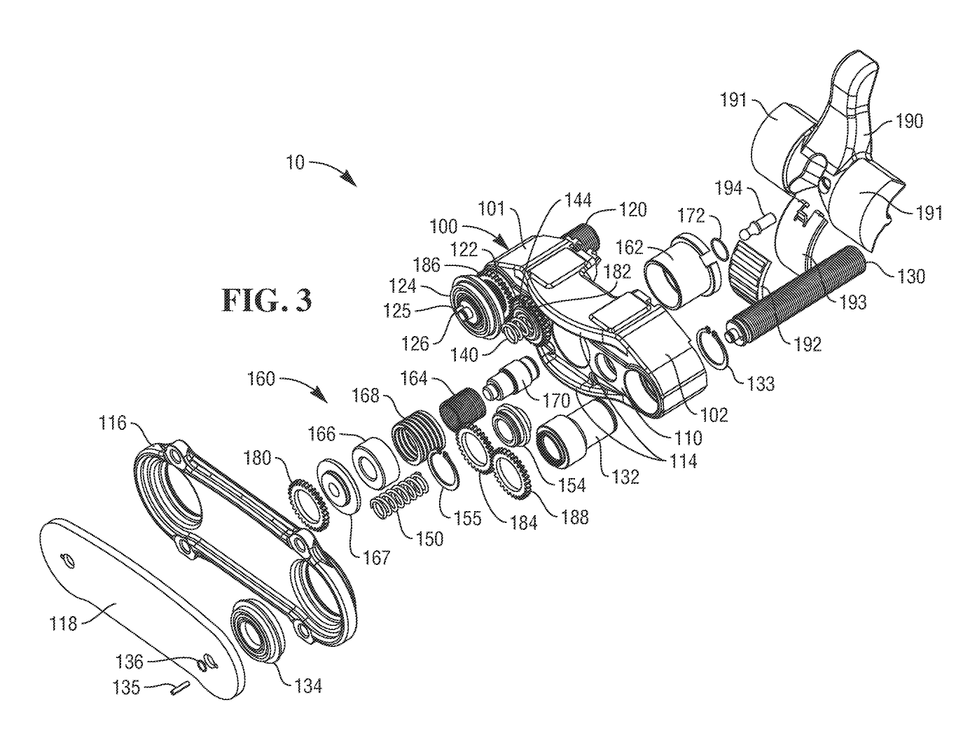

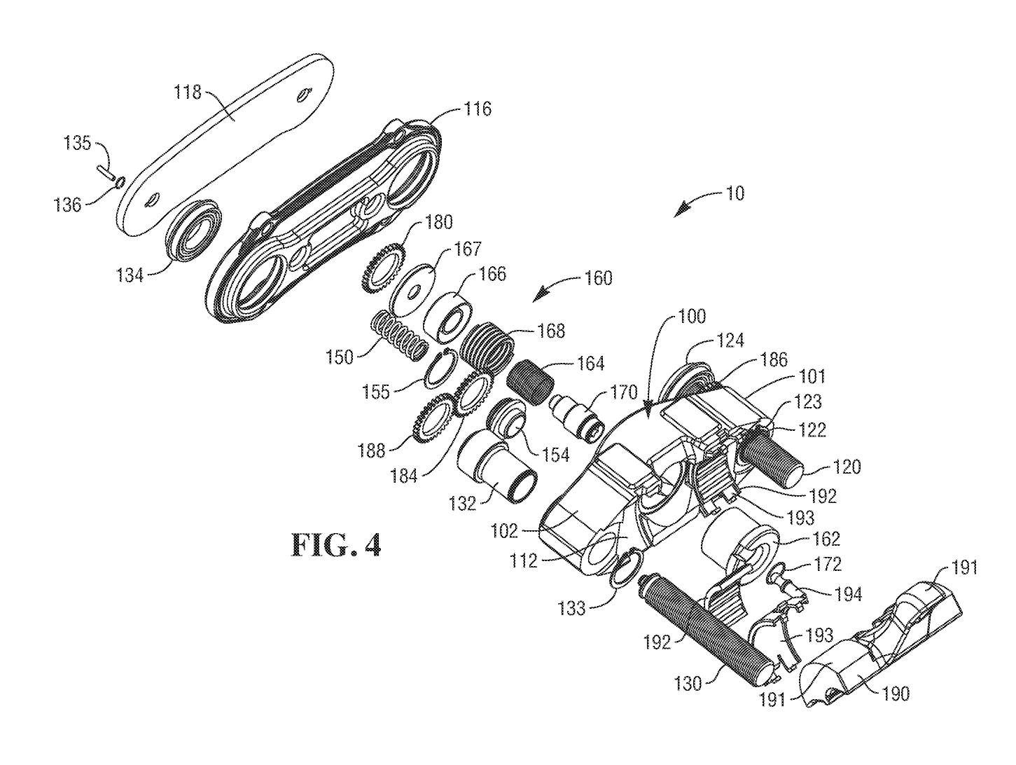

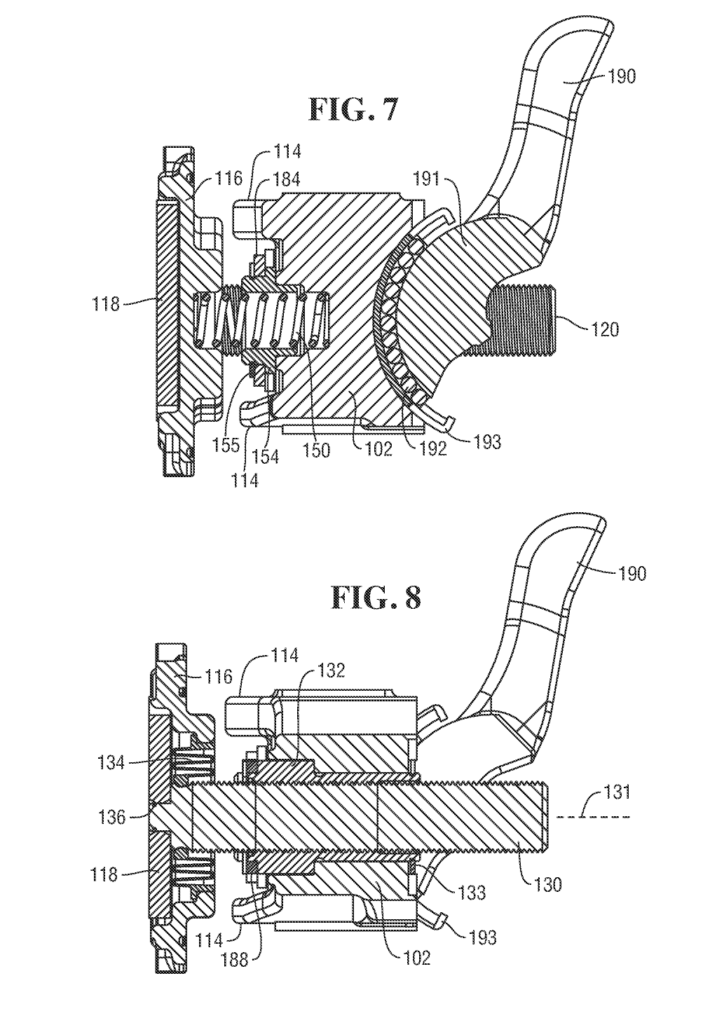

Referring to FIGS. 1-8, brake actuator apparatus 10 is provided for an air disc brake of a vehicle air braking system, such as an air braking of a commercial vehicle like a truck. Brake actuator apparatus 10 includes bridge housing 100 having first housing end portion 101 and second housing end portion 102 distal from first housing end portion. Bridge housing 100 also includes vehicle outboard surface 110 (FIG. 3) extending between first and second housing end portions 101, 102, and vehicle inboard surface 112 (FIG. 4) extending between first and second housing end portions 101, 102.

Outboard surface 110 faces toward a brake rotor (not shown) of the vehicle. Inboard surface 112 faces a direction which is opposite the direction outboard surface 110 faces. Variable ribs 114 may be disposed on at least one of top and bottom portions of outboard surface 110 of bridge housing 100 to provide rigidity to bridge housing 100 while contributing minimal weight. A more rigid bridge housing 100 protects integrity of brake adjuster apparatus 10.

First tappet 120 has a longitudinal central axis 121 disposed at first housing end portion 101 of bridge housing 100 and extends between outboard surface 110 and inboard surface 112. First tappet 120 is connected to first tappet sleeve 122 in conventional manner. First tappet sleeve retaining ring 123 (FIG. 4) secures first tappet sleeve 122 to bridge housing 100. One end of first tappet 120 extends through first tappet boot 124 disposed in faceplate 116, and is secured to pressure plate 118 using first rolled spring pin 125 (FIGS. 1 and 3) and first pressure plate retaining ring 126.

Similarly, second tappet 130 has a longitudinal central axis 131 disposed at second housing end portion 102 of bridge housing 100 and extends between outboard surface 110 and inboard surface 112. Second tappet 130 is connected to second tappet sleeve 132 in conventional manner. Second tappet sleeve retaining ring 133 secures second tappet sleeve 132 to bridge housing 100. One end of second tappet 130 extends through second tappet boot 134 disposed in faceplate 116, and is secured to pressure plate 118 using second rolled spring pin 135 and second pressure plate retaining ring 136.

Each of first and second tappets 120, 130 comprises multiple helix threads. For example, each of first and second tappets 120, 130 may comprise a double helix threaded tappet. For a double helix threaded tappet, twin thread starting points may be 180° apart.

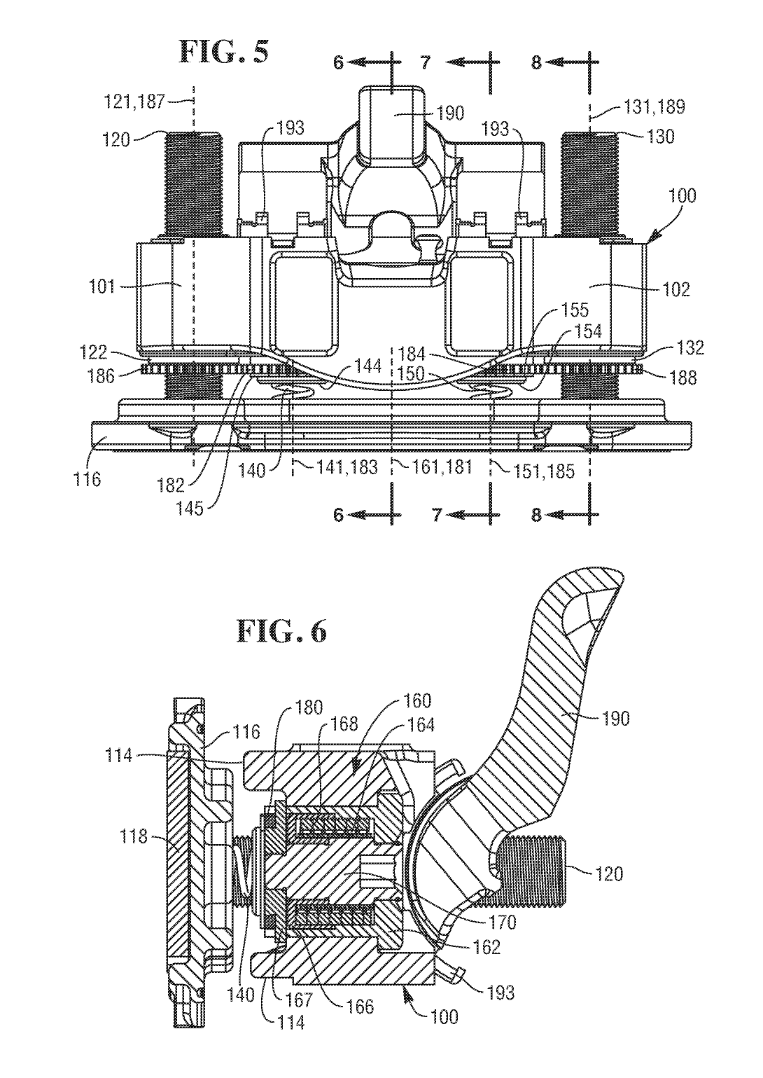

First coil spring 140 has a longitudinal central axis 141 (FIG. 5) and is compressed between a major side surface of faceplate 116 and outboard surface 110 at first housing end portion 101 of bridge housing 100. Similarly, second coil spring 150 has a longitudinal central axis 151 (FIG. 5) and is compressed between the major side surface of faceplate 116 and outboard surface 110 at second housing end portion 102 of bridge housing 100.

Clutch mechanism 160 has a longitudinal central axis 161 (FIG. 5) and is disposed in bridge housing 100 between first and second housing end portions 101, 102 and between outboard surface 110 and inboard surface 112. Clutch mechanism 160 includes clutch sleeve 162 which is connected to spring clutch 164 to clutch cap 166. Clutch cap 166 is support on one side of clutch hub 167 and is connected to spring 168 to clutch drive shaft 170. Clutch drive shaft 170 is connected to a gear train of a plurality of gear wheels. Clutch retaining ring 172 (FIGS. 3 and 4) is connected to clutch sleeve 162 and other components of clutch mechanism 160 to secure components together as a unit to provide a clutch function.

Lever 190 has a pair of eccentric portions 191 (FIGS. 3 and 4) which abuts against a corresponding pair of needle bearings 192 disposed in corresponding needle bearing races 193 disposed on inboard surface 112 of bridge housing 100. Clutch pin 194 is connected between lever 190 and clutch mechanism 160 to convert rotation of lever 190 to rotation of clutch sleeve 162. More specifically, eccentric portions 191 (i.e., cams) of lever 190 are rotated about a pivot axis against needle bearings 192 in response to operation of a brake actuating device (not shown) such as a brake pedal being depressed by a vehicle driver. Operation of clutch mechanism 160 and lever 190 in response to depression of a brake pedal is conventional and, therefore, will not be described.

The gear train of the plurality of gear wheels is disposed on the outboard side of bridge housing 100 (i.e., on the side where outboard surface 110 is located). The plurality of gear wheels may include five gear wheels. Center gear wheel 180 has a longitudinal central axis 181 (FIG. 5) which is coincident with the longitudinal central axis 161 of clutch mechanism 160. Center gear wheel 180 is supported on other side of clutch hub 167 for rotation about its longitudinal central axis 181.

First idler gear wheel 182 has a longitudinal central axis 183 (FIG. 5) which is coincident with the longitudinal central axis 141 of first coil spring 140. First idler gear wheel 182 is supported on one side of first idler gear shaft 144 (FIGS. 3 and 5). First idler gear wheel retaining ring 145 secures first idler gear wheel 182 to first idler gear shaft 144. The other side of first idler gear shaft 144 is supported in outboard surface 110 of bridge housing 100. Gear teeth of first idler gear wheel 182 meshingly engages gear teeth of center gear wheel 180.

Second idler gear wheel 184 has a longitudinal central axis 185 (FIG. 5) which is coincident with the longitudinal central axis 151 of second coil spring 150. Second idler gear wheel 184 is supported on one side of second idler gear shaft 154. Second idler gear wheel retaining ring 155 secures second idler gear wheel 184 to second idler gear shaft 154. The other side of second idler gear shaft 154 is supported in outboard surface 110 of bridge housing 100. Gear teeth of second idler gear wheel 184 meshingly engages gear teeth of center gear wheel 180.

First tappet gear wheel 186 has a longitudinal central axis 187 (FIG. 5) which is coincident with the longitudinal central axis 121 of first tappet 120. First tappet gear wheel 186 is supported on one side of first tappet sleeve 122 (FIG. 3) for rotation about its longitudinal central axis 187. Gear teeth of first tappet gear wheel 186 meshingly engages gear teeth of first idler gear wheel 182.

Second tappet gear wheel 188 has a longitudinal central axis 189 (FIG. 5) which is coincident with the longitudinal central axis 131 of second tappet 130. Second tappet gear wheel 188 is supported on one side of second tappet sleeve 132 for rotation about its longitudinal central axis 189. Gear teeth of second tappet gear wheel 188 meshingly engages gear teeth of second idler gear wheel 184.

Center gear wheel 180, first and second idler gear wheels 182, 184, and first and second tappet gear wheels 186, 188 may be substantially the same size. The longitudinal central axes 181, 183, 185, 187, 189 of the five gear wheels may lie in substantially the same plane and may be substantially parallel to each other.

Rotation of lever 190 about its pivot axis rotates clutch drive shaft 170 which, in turn, rotates center gear wheel 180 of the gear train. When center gear wheel 180 is rotated by clutch mechanism 160, the other four gear wheels 182, 184, 186, 188 are rotated simultaneously. Rotation of gear wheels 180, 182, 184, 186, 188 rotates tappet sleeves 122, 132 which cause tappets 120, 130 to move toward or away the brake rotor depending upon direction of rotation.

Tappets 120, 130 move towards the brake rotor when brakes are applied. Tappets 120, 130 move away from the brake rotor when brakes are released. The extent of movement of tappets 120, 130 away from the brake rotor takes into account brake pad wear and brake rotor wear to compensate for the wear and to provide a proper running clearance between the brake rotor and the brake pads. Adjustment of tappets 120, 130 to compensate for brake pad wear and brake rotor wear is conventional and, therefore, will not be described.

It should be apparent that a force in the outboard direction (i.e., towards the left as viewed looking at FIGS. 6-8) is applied against the center of inboard surface 112 of bridge housing 100 when lever 190 is operated toward the outboard direction. This outboard force results in an inboard reactive force through tappets 120, 130 that stretches outboard surface 110 and compresses inboard surface 112 which, in turn, causes the first and second housing end portions 101, 102 of bridge housing 100 to deflect in the inboard direction relative to the central portion of the bridge housing 100.

During deflection of bridge housing 100, the gear wheels of the gear train mounted on the outboard surface 110 of bridge housing 100 separate slightly since outboard surface 110 stretches, but the gear wheels stay engaged. However, if the gear wheels of the gear train were to be mounted on inboard surface 112 of bridge housing 100, the gear train on the inboard side can compress together during deflection of bridge housing 100 since inboard surface 112 compresses. This would cause interference resulting in excessive gear teeth wear and potential failure. Accordingly, by mounting the gear wheels of the gear train on the outboard side of bridge housing 100, the gear teeth of the gear wheels are protected from excessive wear or potential locking of the gear teeth due to deflection of bridge housing 100.

In addition, five gear wheels of same diameter provide a reduced gear envelope for an overall compact assembly and flexibility in design. Gear wheel positions can be varied to offer optimum positioning of tappets, idler gear wheels, and clutch mechanism to improve performance and clearance envelope. Moreover, a centered clutch provides a symmetrical envelope and offers symmetrically balanced lash for accurate synchronization. A centered clutch also offers compactness and flexibility in design by using bridge housing 100 as a housing component to simplify and protect clutch mechanism 160. This allows for streamlined, lower cost, common tappet sleeves to be used.

It should also be apparent that the force from an air chamber through lever 190 forces bridge housing 100 and tappets 120, 130 outboard during a service brake application. First and second coil springs 140, 150 provide a dual return springs configuration which returns bridge housing 100 with better balance versus a single return spring configuration by pushing directly against lever bearings (i.e., needle bearings 192) of lever 190. Dual return springs also provide a more efficient use of space within bridge housing 100 and thereby allows a shallower brake actuator.

It should further be apparent that the force from an air chamber through lever 190 causes deflection of faceplate 116 which, in turn, affects the faceplate seal. Dual return springs react against bridge housing 100 into faceplate to reduce local forces on faceplate 116. Deflection of faceplate 116 is reduced since spring pressure is distributed across a larger area versus a single larger spring. Smaller dual return springs also reduce localized force against faceplate 116 to improve sealing and create a more balanced return pressure. Moreover, full size idler gear wheels offer space for dual return springs that spread return spring force out across a larger area against faceplate 116. This improves sealing of faceplate 116 due to less localized pressure.

It should also be apparent that a more compact bridge housing and caliper are possible with double helix threaded tappets because they offer the strength of fine threads with the axial travel of coarse threads. More specifically, multiple helix threads allow for a more rapid adjustment of a coarse thread while maintaining the strength of a fine thread. This allows the use of smaller diameter tappets due to the higher strength of the threads.

Also, due to the faster lateral translation of the tappets because of the steeper incline of multiple helix threads (such as double helix threads), components of the clutch mechanism can be made smaller due to less required throw and rotation of the clutch. A smaller clutch mechanism and smaller tappets allow a more compact caliper housing which offers a lighter disc brake caliper with a reduced packaging envelope. A more compact caliper housing is also made possible by five equal sized gears for synchronization, dual return springs, and a centered clutch mechanism.

Although the above-description describes five gear wheels disposed on vehicle outboard surface 110 of bridge housing 100, it is conceivable that a different number of gear wheels be disposed on outboard surface 110 of bridge housing 100.

Also, although the above-description describes two coil springs 140, 150 disposed on vehicle outboard surface 110 of bridge housing 100, it is conceivable that more than two coil springs be disposed on outboard surface 110 of bridge housing 100.

Further, although the above-description describes brake actuator apparatus 100 being used in a heavy vehicle such as a truck, it is conceivable that brake actuator apparatus 100 may be used in other types of commercial vehicles, such as busses for example.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A brake actuator apparatus for an air disc brake of a vehicle air braking system, the brake actuator apparatus comprising:
a bridge housing having (i) a first housing end portion, (ii) a second housing end portion distal from the first housing end portion, (iii) a vehicle outboard surface extending between the first and second housing end portions, and (iv) a vehicle inboard surface extending between the first and second housing end portions;
a first tappet having a longitudinal central axis and disposed at the first housing end portion of the bridge housing and extending between the vehicle outboard surface and the vehicle inboard surface;
a second tappet having a longitudinal central axis and disposed at the second housing end portion of the bridge housing and extending between the vehicle outboard surface and the vehicle inboard surface; and
a gear train disposed on the vehicle outboard surface of the bridge housing and including a plurality of gear wheels operatively coupled to the first and second tappets.

2. A brake actuator apparatus according to claim 1, wherein the plurality of gear wheels includes five gear wheels of substantially the same size.

3. A brake actuator apparatus according to claim 2, wherein (i) a first gear wheel of the five gear wheels has a longitudinal central axis which is coincident with the longitudinal central axis of the first tappet, (ii) a second gear wheel of the five gear wheels has a longitudinal central axis which is coincident with the longitudinal central axis of the second tappet, (iii) a third gear wheel of the five gear wheels disposed between the first and second gear wheels and functioning as a center gear wheel, (iv) a fourth gear wheel of the five gear wheels is meshingly engaged between the first and third gear wheels and functioning as an idler gear wheel between the first and third gear wheels, and (v) a fifth gear wheel of the five gear wheels is meshingly engaged between the second and third gear wheels and functioning as an idler gear wheel between the second and third gear wheels.

4. A brake actuator apparatus according to claim 3, further comprising:
a clutch mechanism disposed in the bridge housing between the first and second housing end portions and between the vehicle inboard surface and the vehicle outboard surface, wherein the clutch mechanism has a longitudinal central axis which is coincident with a longitudinal central axis of the third gear wheel.

5. A brake actuator apparatus according to claim 4, further comprising:
a first coil spring disposed on the vehicle outboard surface of the bridge housing and having a longitudinal central axis which is coincident with a longitudinal central axis of the fourth gear wheel; and
a second coil spring disposed on the vehicle outboard surface of the bridge housing and having a longitudinal central axis which is coincident with a longitudinal central axis of the fifth gear wheel.

6. A brake actuator apparatus according to claim 5, wherein the longitudinal central axes of the first, second, third, fourth, and fifth gear wheels lie in substantially the same plane and are substantially parallel to each other.

7. A brake actuator apparatus according to claim 1, further comprising:
variable ribs disposed on at least one of top and bottom portions of the vehicle outboard surface of the bridge housing to provide rigidity to the bridge housing.

8. A brake actuator apparatus according to claim 1, wherein each of the first and second tappets comprises multiple helix threads.

9. A brake actuator apparatus according to claim 1, wherein the multiple helix threads of each of the first and second tappets comprise double helix threads.

10. A brake actuator apparatus for an air disc brake of a vehicle air braking system, the brake actuator apparatus comprising:
a bridge housing having (i) a first housing end portion, (ii) a second housing end portion distal from the first housing end portion, (iii) a vehicle outboard surface extending between the first and second housing end portions, and (iv) a vehicle inboard surface extending between the first and second housing end portions;
a faceplate having a major side surface facing the vehicle outboard surface of the bridge housing;
a first coil spring having a longitudinal central axis and compressed between the major side surface of the faceplate and the vehicle outboard surface at the first housing end portion of the bridge housing;
a second coil spring having a longitudinal central axis and compressed between the major side surface of the faceplate and the vehicle outboard surface at the second housing end portion of the bridge housing; and
a clutch mechanism disposed in the bridge housing between the first and second housing end portions and between the vehicle inboard surface and the vehicle outboard surface, wherein the clutch mechanism has a longitudinal central axis which lies between the longitudinal central axes of the first and second coil springs.

11. A brake actuator apparatus according to claim 10, wherein the longitudinal central axis of the clutch mechanism lies in substantially the same plane as longitudinal central axes of the first and second coil springs.

12. A brake actuator apparatus according to claim 10, further comprising:
a first tappet disposed at the first housing end portion of the bridge housing and extending between the vehicle outboard surface and the vehicle inboard surface, wherein the first tappet has a longitudinal axis which is parallel to the longitudinal central axis of the first coil spring; and
a second tappet disposed at the second housing end portion of the bridge housing and extending between the vehicle outboard surface and the vehicle inboard surface, wherein the second tappet has a longitudinal axis which is parallel to the longitudinal central axis of the second coil spring.

13. A brake actuator apparatus according to claim 12, further comprising:
a gear train disposed on the vehicle outboard surface of the bridge housing and including a plurality of gear wheels operatively coupled to the first and second tappets.

14. A brake actuator apparatus according to claim 13, wherein the plurality of gear wheels includes five gear wheels of substantially the same size.

15. A brake actuator apparatus according to claim 14, wherein (i) a first gear wheel of the five gear wheels has a longitudinal central axis which is coincident with a longitudinal central axis of the first tappet, (ii) a second gear wheel of the five gear wheels has a longitudinal central axis which is coincident with a longitudinal central axis of the second tappet, (iii) a third gear wheel of the five gear wheels disposed between the first and second gear wheels and functioning as a center gear wheel and having a longitudinal central axis which is coincident with the longitudinal central axis of the clutch mechanism, (iv) a fourth gear wheel of the five gear wheels is meshingly engaged between the first and third gear wheels and functioning as an idler gear wheel between the first and third gear wheels and having a longitudinal central axis which is coincident with the longitudinal central axis of the first coil spring, and (v) a fifth gear wheel of the five gear wheels is meshingly engaged between the second and third gear wheels and functioning as an idler gear wheel between the second and third gear wheels and having a longitudinal central axis which is coincident with the longitudinal central axis of the second coil spring.

16. A brake actuator apparatus according to claim 15, wherein the longitudinal central axes of the first, second, third, fourth, and fifth gear wheels lie in substantially the same plane and are substantially parallel to each other.

17. A brake actuator apparatus for an air disc brake of a vehicle air braking system, the brake actuator apparatus comprising:
a bridge housing having (i) a first housing end portion, (ii) a second housing end portion distal from the first housing end portion, (iii) a vehicle outboard surface extending between the first and second housing end portions, and (iv) a vehicle inboard surface extending between the first and second housing end portions;
a first tappet having a longitudinal central axis disposed at the first housing end portion of the bridge housing and extending between the vehicle outboard surface and the vehicle inboard surface;
a second tappet having a longitudinal central axis disposed at the second housing end portion of the bridge housing and extending between the vehicle outboard surface and the vehicle inboard surface;
a faceplate having a major side surface facing the vehicle outboard surface of the bridge housing;
a first coil spring having a longitudinal central axis and compressed between the major side surface of the faceplate and the vehicle outboard surface at the first housing end portion of the bridge housing;
a second coil spring having a longitudinal central axis and compressed between the major side surface of the faceplate and the vehicle outboard surface at the second housing end portion of the bridge housing;
a clutch mechanism having a longitudinal central axis and disposed in the bridge housing between the first and second housing end portions and between the vehicle inboard surface and the vehicle outboard surface; and
a gear train disposed on the vehicle outboard surface of the bridge housing and including a (i) a center gear wheel having a longitudinal central axis which is coincident with the longitudinal central axis of the clutch mechanism, (ii) a first idler gear wheel having a longitudinal central axis which is coincident with the longitudinal central axis of the first coil spring and meshingly engaged with the center gear wheel, (iii) a first tappet gear wheel having a longitudinal central axis which is coincident with the longitudinal central axis of the first tappet and meshingly engaged with the first idler gear wheel, (iv) a second idler gear wheel having a longitudinal central axis which is coincident with the longitudinal central axis of the second coil spring and meshingly engaged with the center gear wheel, and (v) a second tappet gear wheel having a longitudinal central axis which is coincident with the longitudinal central axis of the second tappet and meshingly engaged with the second idler gear wheel;
wherein (i) the center gear wheel, the first and second idler gear wheels, and the first and second tappet gear wheels are substantially the same size, and (ii) the longitudinal central axes of the center gear wheel, the first and second idler gear wheels, and the first and second tappet gear wheels lie in substantially the same plane and are substantially parallel to each other.

18. A brake actuator apparatus according to claim 17, further comprising:
variable ribs disposed on at least one of top and bottom portions of the vehicle outboard surface of the bridge housing to provide rigidity to the bridge housing.

19. A brake actuator apparatus according to claim 17, wherein each of the first and second tappets comprises multiple helix threads.

20. A brake actuator apparatus according to claim 17, wherein the multiple helix threads of each of the first and second tappets comprise double helix threads.
